(19) United States
(12) Patent Application Publication
(10) Pub. No.: US 2002/0087874 A1
(43) Pub. Date: Jul. 4, 2002

(54) Apparatus and method for integrated chipset content protection

(76) Inventor: Louis A. Lippincott, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/753,246

(22) Filed: Dec. 29, 2000

(51) Int. Cl. G06F 12/14

(52) U.S. Cl. 713/194

(57) ABSTRACT

The inferred hardware assisted decryption apparatus and method utilizes a re-configurable hardware block in conjunction with a processor running a software decryption algorithm that determines the form of the hardware. The re-configurable feature allows the hardware to be changed at regular intervals, thus circumventing any attempts at compromising the hardware. In particular, an encrypted code defining a unique hardware configuration is decrypted based upon a stored key. A unique hardware configuration is then established based upon the encrypted code. A decryption operation is then performed on encrypted content information utilizing the unique hardware configuration.

### BACKGROUND OF THE INVENTION

1. Field of the Invention

The invention is related generally to computer technology and, more particularly, to decryption technology.

2. Background Information

The popularity of integrated chipsets has resulted in an increasing demand for effective decryption techniques. Conventional decryption techniques rely on software only, hardware only or a combination of hardware and software. The software only solution uses a general-purpose processor to run a typically very complicated algorithm, such as PGP, to decrypt the information. The problem with these solutions is their long decryption execution times. In particular, it can take several seconds on a very fast processor to decrypt information that was encrypted with a good public/private key algorithm. These techniques are, however, very secure. In fact, the National Security Agency is concerned with not being able to crack the codes used in some of these algorithms.

The second method, hardware only, uses dedicated hardware to speed up the decryption process. Although speed is a main advantage, hardware only methods once compromised, remain so. In particular, if millions of units have been distributed and later compromised, then they will remain compromised. This is a major problem facing cable set-top descrambler manufacturers.

The third method, a combination of hardware and software, is generally a good compromise between the software only and hardware only methods. Distributed System Service (DSS) systems use a method of combined hardware and software, as do some of the more expensive software packages for the personal computer. The PTEL method, which uses a series of configurable, but limited function, logic blocks is a good example of the combination of hardware and software methods. However, while being fairly secure, they have a couple of the previously mentioned disadvantages. The hardware part can still be deciphered, which can put millions of units at risk. Also, the software part is slow and is therefore used to configure, enable or disable the function and cannot be used to encrypt and decrypt the information being used.

What is needed therefore is the security of the software only method with the speed of the hardware only method, but without the exposure to the risk of being compromised.

### BRIEF DESCRIPTION OF THE DRAWINGS

FIG. 1 is a block diagram of the inferred hardware assisted decryption chipset architecture in accordance with the present invention.

FIG. 2 is a flowchart of an algorithm for implementing the inferred hardware assisted decryption method.

### DETAILED DESCRIPTION OF THE ILLUSTRATED EMBODIMENTS

The present invention provides an inferred hardware assisted decryption (IHAD) electronic system 10 that utilizes a re-configurable hardware block in conjunction with a processor running a software decryption algorithm that determines the form of the hardware. The re-configurable feature of the IHAD allows the hardware to be changed at regular intervals, thus circumventing any attempts at compromising the hardware. For example, a new hardware configuration could be used everyday, or even every transaction. As a result, by the time the hardware is compromised, it is no longer being used. The speed benefits of a hardware only type of decryption can thus be realized without the limitations typically associated with hardware only solutions.

In the following description, some terminology is used to discuss certain functions. For example, an “electronic system” is a system including processing and internal data storage which may include, but is not limited to a computer such as laptops or desktops, servers, set top boxes, imaging devices (e.g., printers facsimile machines, scanners, etc.), financial devices (e.g., ATM machines) and the like. The present invention is thus applicable to any implementation that would benefit from re-configurable hardware protection. “Information” is defined as one or more bits of data, address, and/or control. A “message” is generally defined as information being transferred during one or more bus cycles. A “key” is an encoding and/or decoding parameter used by conventional cryptographic algorithms such as for example, a Data Encryption Algorithm as specified in Data Encryption Standard and the like.

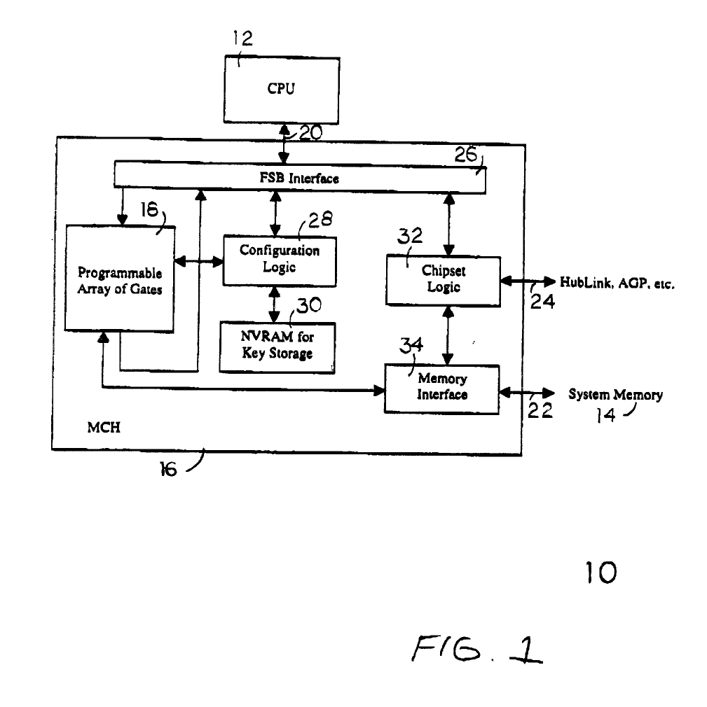

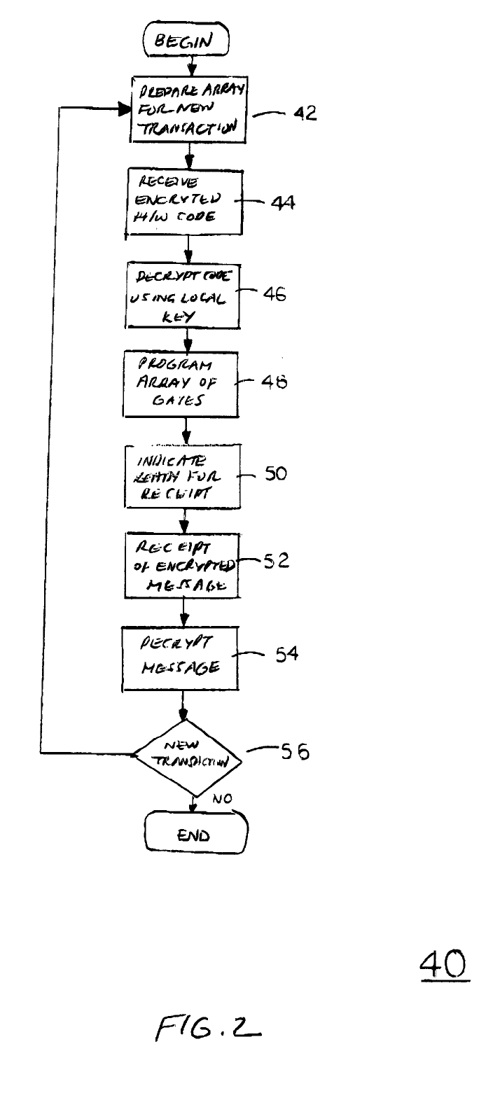

Referring to FIG. 1, an illustrative embodiment of an IHAD enabled chipset electronic system 10 employing the present invention is shown. The electronic system 10 includes a central processing unit (“CPU”) 12 and a system memory 14 coupled together by a chipset 16. The CPU 12 in the system 10 executes the public/private key decryption algorithm (illustrated in FIG. 2 and described herein) and controls the configuration of the programmable logic circuit 18 in the chipset 16. One skilled in the art will recognize that the system memory 14 may be any kind of memory, including but not limited to a dynamic random access memory (“DRAM”) or static random access memory (“SRAM”).

The chipset 16 is circuitry and/or software that operates as an interface between a plurality of buses, such as, for example a CPU bus 20, a system memory bus 22 and a peripheral bus 24. The chipset 16 includes a processor interface 26, programmable array logic circuit 18, such as a programmable array of gates, configuration logic 28, memory 30, chipset logic 32 and memory interface 34. Those of ordinary skill in the art will recognize that the programmable logic circuit 18 may have different types of array modules as well as combinations of two or more types of modules. For illustrative purposes, the present invention will refer to the programmable logic circuit 18 as a programmable array of gates, although one skilled in the art will recognize that other logic circuits could be used as well. The CPU 12 reconfigures the programmable array of gates 18 upon command to circumvent any attempts at compromising the hardware. By the time a user attempts to compromise a particular hardware configuration, the configuration would most likely have been changed at least once. Where security is particularly important, the programmable array of gates 18 could be reconfigured such that a new hardware configuration is used for every transaction. A new hardware configuration for decryption can thus be provided for each transaction and then subsequently discarded.

The chipset 16 operates as a communicative pathway to both the system memory 14 and peripheral devices 36. One or more peripheral devices 36 may be coupled to the bus 24 including, but not limited to, an accelerated graphics port (AGP) bus for connection to an AGP device (e.g., a graphics device), peripheral component interconnect (PCI) bus and hub link (e.g., an interface between computer components). In a typical implementation, such as a PC platform, peripheral components such as network controllers, disk controllers, and floppy disk controllers connect to the chipset 16 through the hub link via bus 24.

For illustrative purposes, the operations of the IHAD electronic system 10 are discussed in relation to the receipt of an encrypted external message, such as an encrypted external message (e.g., real time video) downloaded off the Internet from a source. The encrypted external message, which may be stored in system memory 14 once it is downloaded, is typically encrypted utilizing a public key/private key or other conventional secure method.

Prior to decrypting the message, an encrypted hardware configuration code associated with the encrypted external message is provided to the chipset 16 from the source. The CPU 12, in communication with the chipset 16, decrypts the encrypted hardware configuration code using a local key. The key is extracted from the message by decrypting the message with a key contained in the memory 30 of the chipset 16. The key may be a private key associated with the electronic system 10 if public/private key cryptography is used to secure communication between the IHAD electronic system 10 and other networked systems.

The CPU 12 thus processes the hardware configuration code using a key to which it has access. The public and/or private key used during the initial decryption phase could be held in the memory 30, typically in a non-volatile RAM although a volatile RAM could be used as well. Alternatively, the key could be held in the CPU's ROM or RAM, depending on the requirements of the application. The configuration logic 28 assists the CPU 12 in configuring the programmable array of gates 18.

The CPU 12 thus reads the key, decodes the message and runs a software decryption algorithm that will determine the unique configuration of the hardware. By determining the unique configuration of the hardware, the CPU 12 configures the hardware itself via the programmable array of gates 18. After the encrypted hardware configuration code is decoded, the CPU 12 sends command signals through the configuration logic 28 into the programmable array of gates 18 for reconfiguring the hardware. The configuration logic 28 assists the CPU 12 in configuring the programmable array of gates 18. The memory interface block 34 interfaces the programmable array of gates 18 to the remaining chipset logic 32 and system memory 14. One skilled in the art will recognize that the programmable array of gates 18 can be reconfigured in a conventional manner, for example, by adjusting the wiring of the gates, flip-flops and so forth.

After the decryption hardware is uniquely configured through programming the programmable array of gates 18 to a desired setting, the CPU 12 can optionally notify the source that a secure connection has been established and requests that the associated encrypted external message be transmitted to the IHAD electronic system 10. In the case where the encrypted external message is downloaded from the Internet, the CPU 12 can optionally transmit a signal back over the Internet indicating that a secure connection has been established. The encrypted external message may be routed through bus 24 to the chipset logic 32 and interface 26. The encrypted external message is then applied to the programmable array of gates 18 which decrypts the external message utilizing the unique hardware configuration established earlier. After the external message is decrypted, it is routed to the system memory 14 via memory interface 34 and eventually displayed.

Alternatively, the encrypted external message could be routed to the chipset 16 via the system memory 14. The encrypted external message is then applied to the programmable array of gates 18 (via the memory interface 34) which decrypts the external message utilizing the unique hardware configuration established earlier. After the external message is decrypted, it is routed back to the system memory 14 via memory interface 34 and eventually displayed.

One skilled in the art will recognize that the particular manner (i.e. via the chipset logic or memory interface) the programmable array of gates 18 receives the encrypted external message is not critical to the present invention. After the CPU 12 determines that the decryption hardware is configured as desired, the encrypted external message passes through the new hardware (configured via the programmable array of gates 18) and is decrypted with the new custom hardware configuration until the transaction is complete. The hardware may be reconfigured at regular intervals to circumvent any attempts at compromising the hardware. Correspondingly, there may be instances where it is not necessary to reconfigure the hardware.

Referring to FIG. 2, a flowchart 40 of an algorithm for implementing the present invention is illustrated. Initially, in step 42, a transaction is set up and the CPU 12 clears or verifies the programmable array of gates 18. The CPU 12 then receives the encrypted hardware configuration code (i.e. encrypted version of the hardware through the chipset 16) from a source that is sending the encrypted external message (step 44). The CPU 12 decrypts the hardware configuration code using a local key (step 46). The non-volatile RAM could be used to hold the public and/or private key used during the initial decryption phase. Alternatively, the key could be held in the CPU's ROM or RAM, depending on the requirements of the application.

The CPU 12 then programs the array of gates 18 (step 48). The CPU 12 would execute a public/private key decryption algorithm and control the configuration of the programmable array of gates 18 (step 50). The exact details of how the configuration logic 28 configures the programmable array of gates 18 is not critical to the present invention and any conventional method may be utilized. The CPU 12 then notifies the source that the decryption hardware is properly configured and ready to decrypt the associated encrypted external message (step 52). The encrypted external message is routed through the new hardware configuration and accordingly decrypted (step 54).

One skilled in the art will recognize that the present invention is potentially valuable to anyone involved in the secure distribution of information via electronic digital means. For example, the invention would be useful in platforms that receive entertainment type information for immediate use by the consumer.

Having now described the invention in accordance with the requirements of the patent statutes, those skilled in the art will understand how to make changes and modifications to the present invention to meet their specific requirements or conditions. Such changes and modifications may be made without departing from the scope and spirit of the invention as set forth in the following claims.

What is claimed is:

1. A computer product, comprising:
first computer readable program code embodied in a computer usable medium to cause a computer to store a key associated with an encrypted code defining a unique hardware configuration;
second computer readable program code embodied in a computer usable medium to cause a computer to decrypt the encrypted code based upon the stored key;
third computer readable program code embodied in a computer usable medium to cause a computer to program a logic array based upon the decrypted key to establish a unique hardware configuration; and
fourth computer readable program code embodied in a computer usable medium to cause a computer to perform a decryption operation on encrypted information utilizing the unique hardware configuration.

2. The computer product claimed in claim 1, further comprising:
fifth computer readable program code embodied in a computer usable medium to cause a computer to route encrypted information through a peripheral device to the logic array.

3. The computer product claimed in claim 1, further comprising:
fifth computer readable program code embodied in a computer usable medium to cause a computer to route the incoming information through a memory interface to the logic array.

4. The computer product claimed in claim 1, where in the logic array includes a programmable an array of gates.

5. An electronic system comprising:
at least one peripheral device;
a memory for storing a key associated with incoming information; and
a chipset in communication with the at least one peripheral device, the chipset including circuitry to program an array of gates based upon the key associated with the incoming information and decrypt the incoming information based on the programmed array of gates and circuitry to perform a decryption operation on the incoming information based on the configured array of gates.

6. The electronic system claimed in claim 5, further comprising:
circuitry for routing the incoming information from a peripheral device through the configured array of gates.

7. The electronic system claimed in claim 5, further comprising:
circuitry for routing the incoming information from a memory device through the configured array of gates.

8. The electronic system claimed in claim 5, wherein the memory is a nonvolatile memory.

9. The electronic system claimed in claim 5, wherein the key is a public key.

10. The electronic system claimed in claim 8, wherein the key is a non-public key.

11. A method for decrypting encrypted information, comprising:
storing a key associated with an encrypted code defining a unique hardware configuration;
decrypting the encrypted code based upon the stored key;
establishing a unique hardware configuration based upon the encrypted code; and
performing a decryption operation on encrypted information utilizing the unique hardware configuration.

12. The method claimed in claim 11, further comprising:
routing encrypted information through a peripheral device to the logic array.

13. The method claimed in claim 11, further comprising:
routing the incoming information through a memory interface to the logic array.

14. The method claimed in claim 1, wherein the logic array includes a programmable an array of gates.

15. A method for decrypting encrypted information, comprising:
initiating a programmable array of gates;
receiving a code related to an encrypted version of hardware;
decrypting the code using a key;
programming the programmable array of gates to provide a unique hardware configuration; and
decrypting the information utilizing the unique hardware configuration.

16. The method claim in claim 15, further comprising:
routing the incoming information through a peripheral device to the configured array of gates.

17. The method claimed in claim 15, further comprising:
routing the incoming information through a memory interface to the configured array of gates.

18. The method claimed in claim 15, wherein programming an array of gates based upon the key associated with the incoming information further comprises:
programming the array of gates to provide for a unique hardware configuration upon command.

19. The method claimed in claim 15, wherein programming an array of gates based upon the key associated with the incoming information further comprises:
receiving instructions from a processor.

20. The method claimed in claim 15, further comprising storing the key in non-volatile memory.
